(19) United States
(12) Patent Application Publication
(10) Pub. No.: US 2025/0259448 A1
(43) Pub. Date: Aug. 14, 2025

(54) SYSTEM AND METHOD USING REASONING FOR VIDEO ANOMALY DETECTION WITH LARGE LANGUAGE MODELS

(71) Applicant: Honda Motor Co., Ltd., Tokyo (JP)

(72) Inventors: Yuchen YANG, Towson, MD (US); Kwonjoon LEE, San Jose, CA (US); Shao-Yuan LO, Milpitas, CA (US); Behzad DARIUSH, San Ramon, CA (US)

(73) Assignee: Honda Motor Co., Ltd., Tokyo (JP)

(21) Appl. No.: 18/669,706

(22) Filed: May 21, 2024

Related U.S. Application Data
(60) Provisional application No. 63/553,550, filed on Feb. 14, 2024.

(51) Int. Cl. G06V 20/40; G06V 10/44; G06V 20/70

(52) U.S. Cl. CPC G06V 20/44; G06V 10/44; G06V 20/70

(57) ABSTRACT

A video anomaly detection (VAD) system may have an induction stage receiving a plurality of video frames as a reference and deriving a rule for a normal event occurrence and a corresponding rule for an anomaly event occurrence by contrasting the corresponding rule for the anomaly event occurrence to the rule for the normal event occurrence. The VAD system may have a deduction stage applying the rule for the normal event occurrence and the corresponding rule for the anomaly event occurrence to determine anomalies in non-reference video frames.

### RELATED APPLICATIONS

This patent application is related to U.S. Provisional Application No. 63/553,550 filed Feb. 14, 2024, entitled “Follow the Rules: Reasoning for Video Anomaly Detection with Large Language Models”, in the names of the same inventors and which is incorporated herein by reference in its entirety. The present patent application claims the benefit under 35 U.S.C § 119(e) of the aforementioned provisional application.

### BACKGROUND

Video Anomaly Detection (VAD) may be important. VAD may be used to identify unusual events in surveillance videos, i.e., sudden movements, traffic accidents, or violence. VAD may be a unique and challenging problem under the assumption that anomalies may be rare in real life, leading to the lack of large-scale labeled anomaly data. To handle this challenge, conventional self-supervised learning-based VAD methods may train a model using normal data, typically the visual features from video frames. The model then may identify any instances not recognized or poorly reconstructed by it, i.e., indicating they may have deviated from the learned normal patterns as anomalies. This learning-based method may face two primary issues: first, it may underperform on unseen data distributions, thereby struggling with the diverse range of anomalies in various scenes and the differences between real-world and synthetic data; and second, it may only generate an anomaly score that lacks intuitiveness for human understanding.

Some may see the potential in using natural language reasoning to tackle these challenges, which has not yet been explored in current methods. Intuitively, language may provide a high-level and uniform way to describe and reason about anomalies like “running” beyond the constraints of visual data variability. It may enable learning from limited data, which may allow the application of known rules to unseen situations. Thus, it may enhance the system's adaptability and capability to identify anomalies across diverse datasets. Moreover, this approach may translate outcomes into a human-understandable format. The emergence of LLMs with strong reasoning capabilities may bring this vision to reality. However, the broad commonsense knowledge in LLMs might not always align with specific applications, which may inaccurately label certain anomalies as normal due to their generic context, e.g., GPT-4V may treat “running” as typically normal while overlooking its anomalous nature in a restricted campus area. This may highlight the necessity for tailored approaches that steer LLMs reasoning strengths while accounting for the unique contexts.

Limitations and disadvantages of conventional and traditional approaches will become apparent to one of skill in the art, through comparison of described method with some aspects of the present disclosure, as set forth in the remainder of the present application and with reference to the drawings

### SUMMARY

According to an embodiment of the disclosure, a video anomaly detection (VAD) system is provided. The VAD system may have an induction stage. The induction stage may receive a plurality of video frames as a reference and may derive a rule for a normal event occurrence and a corresponding rule for an anomaly event occurrence by contrasting the corresponding rule for the anomaly event occurrence to the rule for the normal event occurrence. A deduction stage may apply the rule for the normal event occurrence and the corresponding rule for the anomaly event occurrence to determine anomalies in non-reference video frames.

According to an embodiment of the disclosure, a method for VAD is provided. The method may receive a plurality of video frames as a reference. The method may derive a rule for a normal event occurrence and a corresponding rule for an anomaly event occurrence by contrasting the corresponding rule for the anomaly event occurrence to the rule for the normal event occurrence. The method may further apply the rule for the normal event occurrence and the corresponding rule for the anomaly event occurrence to determine anomalies in non-reference video frames.

According to an embodiment of the disclosure, a method for VAD is provided. The method may be implemented using a computer system having a processor communicatively coupled to a memory device. The method may receive a plurality of video frames as a reference. The method may convert visual features into textual descriptions from the plurality of video frames as the reference. The method may query the textual descriptions to detect patterns. The method may further generate a rule for a normal event occurrence and a corresponding rule for an anomaly event occurrence based on the detected patterns. The method may further apply randomize smoothing to generate the rule for the normal event occurrence and the corresponding rule for the anomaly event occurrence. The method may process non-reference video frames to output textual descriptions from the non-reference video frames. The method may apply the rule for the normal event occurrence and the corresponding rule for the anomaly event occurrence to determine anomalies in the non-reference video frames. The method may further apply exponential majority smoothing for perception error reduction and temporal consistency. The method may apply a double-check system to reduce false negative outputs.

### BRIEF DESCRIPTION OF THE DRAWINGS

FIG. 1 is a block diagram of an exemplary device for video anomaly detection in accordance with an embodiment of the disclosure;

FIG. 2 is a block diagram of an exemplary device for video anomaly detection in accordance with an embodiment of the disclosure;

FIGS. 3A-3C are graphs displaying the effects of the hyperparameters in exemplary rule aggregation and perception smoothing modules in the device for video anomaly in accordance with an embodiment of the disclosure;

FIG. 4 is a block diagram of a computer-readable medium or computer-readable device including processor-executable instructions for exemplary video anomaly detection, in accordance with an embodiment of the disclosure; and

FIG. 5 is a block diagram of a computer system for exemplary video anomaly detection, in accordance with an embodiment of the disclosure.

### DETAILED DESCRIPTION

Anomaly detection plays a crucial role in video surveillance to ensure security. However, existing Video Anomaly Detection (VAD) methods lack a reasoning framework, thus it may struggle to make informed and explainable decisions. The present disclosure provides an AnomalyRuler which may utilize the reasoning ability of Large Language Models (LLMs). The direct application of LLMs may be flawed due to two challenges. First, the powerful commonsense knowledge inherent in LLMs may mistakenly predict certain anomaly scenarios as normal due to their general context, such as considering running as a typical normal, while failing to recognize its anomaly in a restricted campus area. Second, perception errors during frame perception may lead to inaccurate anomaly detection. Due to the aforementioned, one may design an induction stage by deriving contextual rules from a few normal frames' interpretations, steering LLMs for accurate VAD with reasoning in specialized situations. For the latter, one may integrate three modules to enhance robustness: rule aggregation with randomized smoothing, perception smoothing with exponential majority smoothing, and robust reasoning with a double-check mechanism. AnomalyRuler may be the first few-shot prompting approach that integrates LLM reasoning into self-supervised VAD without any training or fine-tuning. Comprehensive experiments across four VAD benchmarks may demonstrate that AnomalyRuler is a generalized and effective framework. It may outperform the state-of-the-art from 1.1% to 8.6% AUC.

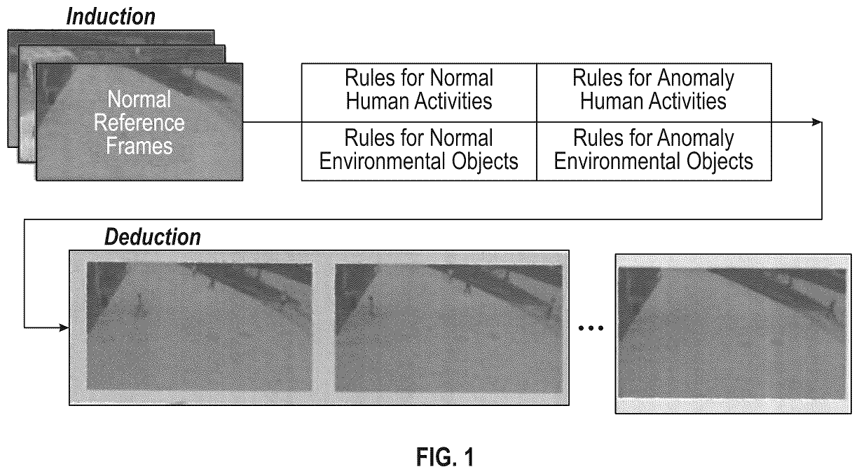

AnomalyRuler may be a first rule-guided reasoning VAD approach with LLMs. Unlike traditional self-supervised learning-based methods, AnomalyRuler adopts a novel self-supervised few-shot prompting strategy that uses a few examples of normal behavior to create rules with LLMs and then applies these rules to find anomalies. AnomalyRuler works in two stages as shown in FIG. 1. First, the induction stage may function as a training process in standard VAD methods. AnomalyRuler may take some normal video frames as a reference to derive rules about what is normal. It may then figure out what are the rules for anomaly by contrasting them to the rules for normal. Second, in the deduction stage, similar to the testing phrase in previous methods, AnomalyRuler may use the rules derived in the induction stage to spot anomalies in unseen test frames. This way, AnomalyRuler may blend the best of old-school VAD techniques with the smart reasoning of LLMs. In this way, AnomalyRuler may utilizes the advanced reasoning capabilities of LLMs and guides them towards solving the VAD tasks.

As may be seen in FIG. 1, there may be four people in this frame. Starting from the left, the first person may be walking, the second person may also be walking but further away, the third person may be riding a skateboard, and the fourth person may also be on a skateboard. Other than people, there may be two utility hole covers visible on the ground. First, AnomalyRuler may check for human activities: (1) Walking: Two people may be walking, which matches: Normal Human Activities, Rule number 1. (2) Skateboarding: Two people may be on skateboards, which matches: Anomaly Human Activities, Rule number 1. Second, AnomalyRuler may check for environmental objects: (1) Manhole covers: Two utility hole covers may be visible, which matches: Normal environmental objects, Rule number: 2. Based on the information provided, the normal activities are people walking, and the anomaly activities are people skateboarding. The normal objects are utility hole covers, and there are no anomaly objects mentioned in the description. Therefore, this frame may be an anomaly due to the presence of anomaly human activities.

AnomalyRuler may have three key advantages. First, it may be adapted across different datasets due to the high-level abstraction of natural language, allowing for flexible context awareness, i.e., handling complex scenes through reasoning with LLM. Second, the few-shot prompting approach may make AnomalyRuler have no need for any training or fine-tuning, thus computation efficiency. At the same time, AnomalyRuler may implement three robustness enhancement modules to make the few-shot prompting more reliable, i.e., rule aggregation with randomized smoothing to lower rule generation errors, perception smoothing via an Exponential Majority Smoothing for perception error reduction and temporal consistency, and a robust reasoning module with a double-check system for more reliable reasoning output. Third, AnomalyRuler may be a general and flexible framework that may accommodate various LLMs, which may make it effective with both closed-source GPT models and open-source alternatives like Mitral. These features not only address the limitations of the existing VAD methods but may also improve the performance. Present experimental results may show that AnomalyRuler may outperform the state-of-the-art from 1.1% to 8.6% AUC, especially on the two most challenged datasets ShanghaiTech and UBNormal.

In summary, AnomalyRule may provide three benefits over existing methods:
AnomalyRuler may be the first VAD method to use rule-based reasoning with LLMs, bridging the reasoning gap in VAD tasks.
AnomalyRuler may adopt a novel few-shot prompting approach, which may eliminate the need for training or fine-tuning, making it flexible to different scenarios, and having domain adaptation ability across different datasets.
AnomalyRuler may serve as a general framework showing how to guide LLM's common sense knowledge towards specific tasks like VAD. The proposed robustness enhancement modules may show effectiveness in mitigating errors, leading to more reliable outcomes with LLMs applications.

### Video Anomaly Detection

Traditional Video Anomaly Detection (VAD) may face the challenge of identifying unexpected events due to the lack of labeled anomaly data. Most recent approaches may adopt self-supervised learning, which may learn a model using only normal training data. During inference, deviations from this model, e.g., poor performance, may be labeled as anomalies. Early distance-based studies may utilize Support Vector Machines (SVM) or binary classifiers. However, the presence of generative models like auto-encoders, GANs, and diffusion models may shift focus to reconstruction-based methods. These approaches may aim for pixel-level generation to either reconstruct input frames or predict missing frames, achieving improved performance. Yet, they may often miss the reasoning behind anomalies, which makes the detection results difficult for humans to interpret. To one's best knowledge, there is currently no existing work in self-supervised VAD that may incorporate natural language reasoning, which may potentially make anomaly detection more understandable. Some related studies may explore utilizing LLMs in anomaly detection. There are methods that have applies an LLM as a “semantic reasoning” module to analyze anomaly in driving scenes. However, this method relies on manually crafted prompts based on predefined concepts of normally and anomaly, limiting its adaptability across different scenarios. Other methods may use a Large Vision-Language Model for anomaly detection in industrial images. These methods may introduce a weakly-supervised VAD approach by fine-tuning Video-LLaMA with labeled normal and anomaly data. These initiatives mark a promising step towards integrating more flexible, understanding-based models into VAD, though the field is still in its infancy in fully exploiting natural language reasoning for enhanced interpretability and flexibility.

### Large Language Models

### Reasoning Over Natural Language

Large language models (LLMs) with their strong commonsense knowledge and reasoning capabilities, may significantly enhance context comprehension and decision-making processes in artificial intelligence (AI) applications. However, within the domain of VAD, the effectiveness of this ability may rely on the guidance by rules. Consider the example of “riding a bicycle”. While this activity may typically be normal in everyday commuting contexts, i.e., a piece of commonsense knowledge grasped by LLMs, it may become anomalous within certain settings, such as a restricted campus area in ShanghaiTech dataset. To discover specialized knowledge for the VAD task, one may propose an induction stage to use an LLM to induce rules from a representative set of normal scenarios, which may effectively differentiate the normal and anomaly in various contexts.

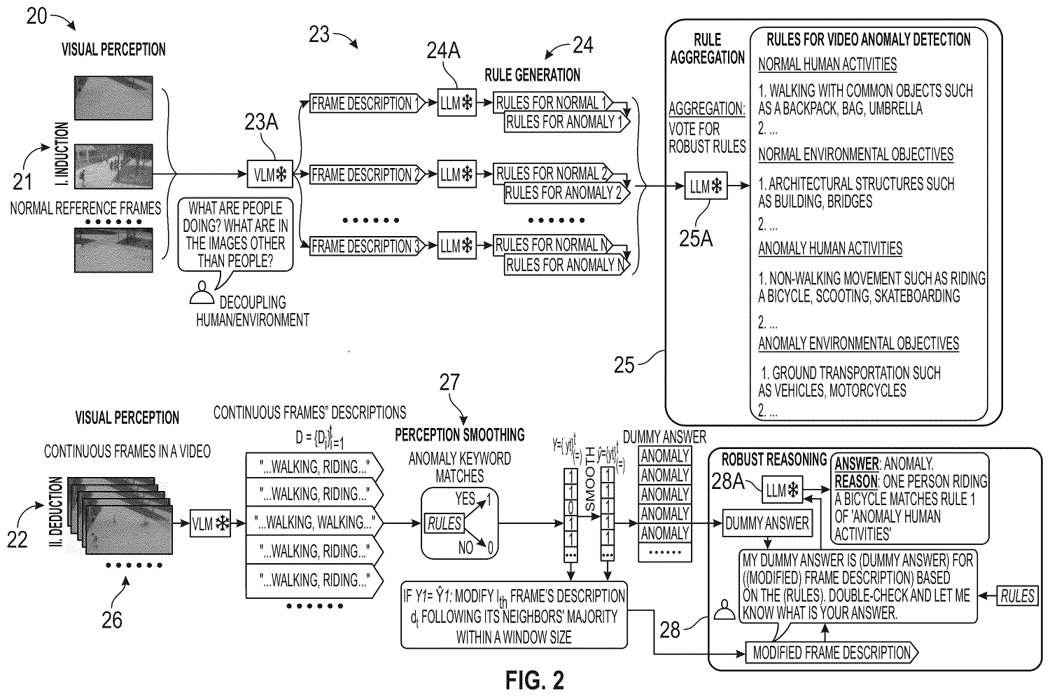

Referring to FIG. 2, the AnomalyRuler 20 may be seen. The AnomalyRuler 20 may consists of two stages: induction 21 and deduction 22. The top part of FIG. 2 may illustrate the components in the induction stage 21. The induction stage 21 may be designed to induct accurate and robust rules from a few normal examples to steer LLMs focus on specific human activities and their interaction with the environmental context. To achieve this goal, induction stage 21 may be designed with three modules in the induction pipeline: visual perception module 23, rule generation module 24, and rule aggregation module 25. Each of these modules may be defined in detailed below.

### Visual Perception

Acknowledging the necessity of LLMs' reasoning ability in the AnomalyRuler 20, one may designate the visual perception module 23 as the initial step in the pipeline. The visual perception module 23 may utilize a Vision Language Model (VLM) 23A to convert visual features into textual descriptions. To optimize the use of the pre-trained VLM 23A, one may consider the inherent focus of VAD on the interaction between humans and their environment within surveillance video contexts. Thus, a decoupling strategy may be adopted where visual perception is divided into two categories, i.e., human activities and environmental objects. There may be two advantages:

### Context Awareness

A key challenge in VAD may be to increase context awareness. Prior methods to integrate both foreground object and background scene features as a traditional full-shot training VAD methods, emphasized the importance of context in VAD. AnomalyRuler 20 may demonstrate that the decoupling strategy also improves the context awareness of the proposed few-shot prompting approach without any training.

### Reasoning Efficiency

This decoupling strategy may align with the divide-and-conquer principle, proven to enhance LLMs” reasoning ability as shown in prior works. This approach may not only enable the VLM to achieve more precise perceptions by concentrating on specific categories, i.e., human and environment, but it may also simplify the followed rule generation module 24 by dividing the task into two subproblems, i.e., rules for human activities and rules for environmental objects.

To illustrate the practical improvements of the decoupling strategy in AnomalyRuler 20, an ablation study comparing performance with and without may be shown below.

### Rule Generation

After obtaining the text descriptions of normal frames, the next step may involve leveraging the reasoning ability of a frozen LLM 24A to derive rules from them. This may be done by querying the LLM 24A about the descriptions assuming that the descriptions are normal. One may design the rule generation module 24 to mimic human cognitive processes, deriving rules step by step from the observed patterns. This approach may align with the chain-of-thought strategy, yet it may further be refined with guidance specific to VAD tasks rather than merely prompting the LLM 24A with “think step by step”. One may term this approach the guided chain-of-thought strategy, which includes three elements:

### Human and Environment

Following the visual perception module 23, one may generate rules for both human activities and environmental objectives. Despite the reasoning efficiency as was discussed in the visual perception module, including environmental objectives such as vehicles or scene factors, alongside human activities may enrich the generated rules. This may be important to VAD tasks where anomalies may not solely be attributed to human activities but also their interactions with the environment.

### Normal and Anomaly

Given that the frames utilized for rule generation may be randomly sampled from the training set, i.e., ground truth normal samples, the first step may be to guide the LLM 24A in deriving normal rules based on these frame descriptions. For example, considering human activities, if “walking” is a prevalent pattern, it may be included in the normal rules. AnomalyRuler 20 may then derive anomaly rules based on the defined normal rules, such as identifying “non-walking movement” as an anomaly. This approach may regulate the rule generation in a step-by-step manner, while setting a clear and comprehensible decision boundary between normal and anomaly even though AnomalyRuler 20 may only have access to one-class normal frames.

### Abstract and Concrete

Considering the specific normal and anomaly sets may be infinite, this approach enables AnomalyRuler 20 to engage in analogy. It starts from an abstract concept and may then effectively generalize to more concrete examples. Taking the same “walking” example, the definition of a normal rule may now be expanded to “walking, whether alone or with others.” Consequently, the anomaly rule may evolve to include specific non-walking movements, i.e., “non-walking movement, such as riding a bicycle, scooting, or skateboarding.” This strategy may not only help the LLM 24A understand the rules better with detailed examples but may also allow the LLM 24A to use analogy for reasoning, without using exhaustive techniques to go through every possible scenario.

To show the practical improvements of the guided chain-of-thought strategy in AnomalyRuler 20, an ablation study is shown below.

### Rule Aggregation

Despite the size and generalization of models, errors may still be possible. For example, the VLM 23A in the visual perception module 23 may sometimes incorrectly interpret “walking” as “skateboarding”. This issue may lead one to consider randomize smoothing, i.e., a technique that may improve model robustness against adversarial attacks by adding random noise to inputs and using the aggregate of these varied responses as the final prediction. To adapt this concept to AnomalyRuler 20, the idea is that while the perception error may happen on a single input, it is less likely to consistently happen across many randomly sampled inputs. Thus by aggregating these outputs, AnomalyRuler 20 may generate rules that are more resilient to individual errors.

AnomalyRuler 20 may first randomly samples n batches of normal frames, each batch containing m frames, from a uniform distribution. The process of visual perception and rule generation may then be executed independently for each batch, resulting in n independent sets of generated rules.

To aggregate these rules, AnomalyRuler 20 may integrate an additional LLM 25A with a voting mechanism. The high-level idea may be to keep rule elements that consistently appear across the n sets, thereby filtering out minority instances, such as the incorrect identification of “skateboarding” as normal, i.e., a mistake originating from the visual perception module.

To show the effectiveness of the rule aggregation in AnomalyRuler 20, one may we ablate this module and its hyperparameter n and m as shown below.

### Deduction

Following the induction stage 21 where LLMs may be guided to derive a set of robust rules, the deduction stage 22 may apply these rules as a context for VAD tasks. The bottom part of FIG. 2 may show the modules in the deduction stage 22. The high-level idea may be to precisely perceive each frame of a video, then utilize the LLM to reason if these descriptions are normal or anomaly based on rules. To achieve this goal, the deduction stage 22 may have three modules. First, the visual perception module 26 may work with the same strategy as described in the induction stage, which processes continuous frames from each video in the test set and outputs a series of frame descriptions D={d₁, d₂, . . . , dₜ}. Second, the perception smoothing module 27 may reduce errors using a novel technique named exponential majority smoothing. This step alone may provide preliminary detection results, referred to as AnomalyRuler-dummy. Third, the robust reasoning module 28 may utilize an LLM 28A to double-check the preliminary detection results against the rules and do reasoning.

### Perception Smoothing

As discussed above, perception errors may happen in the induction stage 21, and this concern may extend to the deduction stage 22 as well. To address this challenge, the perception smoothing module 27 may use a proposed mechanism named exponential majority smoothing. This mechanism may mitigate the errors considering temporal consistency in the VAD tasks, i.e., that movements are continuous and should exhibit consistent patterns over time. One may utilize the results of this smoothing to guide the correction of frame descriptions, enhancing AnomalyRuler's robustness to errors. There may be four key steps:

### Initial Anomaly Matching

For the continuous frame descriptions D={d₁, d₂, . . . , dₜ}, AnomalyRuler 20 may first match specific keywords K found within the anomaly rules from the induction stage 21 and assign dᵢ with label yᵢ where i∈[1, t] may represent the predicted label. Formally, one may have yᵢ=1 if ∃k∈K⊆dᵢ, which may indicate an anomaly triggered by keywords such as ing-verb “riding” or “running”. Otherwise, yᵢ=0 may indicate the normal. One may denote the initial matching predictions as Y={y₁, y₂, . . . , yₙ}.

### Exponential Majority Smoothing

This may be a two-step smoothing process as a sequential of exponential moving average smoothing and majority smoothing:

Step I: Exponential Moving Average Smoothing. The Exponential Moving Average (EMA) may be a type of moving average that may place a greater weight and significance on the most recent data points. One may denote the EMA smoothed prediction E={e₁, e₂, . . . , eₙ} where eᵢ=1 or 0. Formally, we have:

$${e}_{i} = \{ \begin{matrix}1 & if {s}_{i} > \frac{1}{t} {\sum }_{i = 1}^{t} {s}_{i} \\ 0 & otherwise\end{matrix}$$

where sᵢ=α·yᵢ+(1−α)·sᵢ₋₁ with s₀=y₁. One may denote α as the parameter that influences the weighting of data points in the EMA calculation.

Step II: Majority Smoothing. Tailored specifically for motion analysis in VAD, one may propose a majority smooth that may focus on the continuity in human or object movements. Majority Smooth may build up on E and may adjust it to reflect the most common or “majority” state within a specified window. One may denote the majority smoothing prediction Ý={ŷ₁, ŷ₂, . . . , ýₜ} where ŷᵢ=1 or 0. Formally, we have:

$${\hat{y}}_{i} = \{ \begin{matrix}1 & if {\sum }_{j = max ( 1 , i - p )}^{min ( i + p , t )} {e}_{j} > ( min ( i + p , t ) - max ( 1 , i - p ) + 1 ) / 2 \\ 0 & otherwise\end{matrix}$$

where p is the parameter padding size around the index i, and the window size may adapt based on the position of i within the sequence, ensuring that the window does not extend beyond the boundaries determined by the range from max(1, i−p) to min(i+p, t). Thus the adaptive window size w is defined as: min(i+p, t)−max(1, i−p)+1.

In summary, this two-step exponential majority smoothing may effectively mitigate errors that happen in AnomalyRuler 20. Compared with using initial matching predictions Y as the input of majority smoothing, using E from EMA smoothing as the input may lead to more reliable majority decisions Y, as it may minimize the chances of misclassifying data points due to random fluctuations.

### AnomalyRuler-Dummy

Given that Y may represents the initial detection results of AnomalyRuler 20, one may further assess these by calculating an anomaly score through a secondary EMA. Specifically, the anomaly scores, denoted as A={a₁, a₂, . . . , aₙ}, where:

$${a}_{i} = \frac{1}{t} {\sum }_{i - 1}^{t} ( {α}_{i} \cdot {\hat{y}}_{i} ( 1 - {α}_{i} ) \cdot {a}_{i - 1} ) , and {α}_{i} = \frac{1}{t} {\sum }_{i = 1}^{t} {s}_{i}$$

represents a dynamic weight derived from Step I above. One may denote the above procedure AnomalyRuler-dummy as a baseline of the method, which may provide a dummy answer, i.e., “Anomaly” if ŷᵢ=1 otherwise “Normal”, with an anomaly score that may be comparable with the state-of-the-art VAD methods. Subsequently, AnomalyRuler 20 may utilize the dummy answer in the robust reasoning module for further analysis.

### Description Modification

In this step, AnomalyRuler 20 may modify the description D comparing Y and Ý and may output a modified D \hat{ }. If yᵢ=0 while ŷᵢ=1, indicating a false negative in the perception module, AnomalyRuler 20 may correct dᵢ by adding “There is a person {k}.”, where k∈K is the most frequent anomaly keyword within the window size w. Conversely, if yᵢ=1 while ŷᵢ=0, indicating a false positive in the perception module, AnomalyRuler 20 may modify dᵢ by removing parts of the description that contain the anomaly keyword k.

### Robust Reasoning

In the robust reasoning module 28, AnomalyRuler 20 may utilize an LLM 28A to achieve the reasoning task for VAD, with the robust rule derived from the induction stage 21 as a context. The LLM 28A may take each frame's modified description d\hat{ }ᵢ with its dummy answer, i.e., either “Anomaly” or “Normal” generated from AnomalyRuler-dummy. To guarantee reliable results, AnomalyRuler 20 may prompt the LLM 28A for a second review to check if the dummy answer truly matches the description d\hat{ }ᵢ based on the robust rules. This additional step of double-checking instead of directly prompting LLM 28A to analyze d\hat{ }ᵢ may enhance the decision-making, by using the dummy answer as a hint, which may boost AnomalyRuler 20 to lower the rate of missed anomalies (false negatives) and may ensure that its reasoning aligns more closely with the rules. Besides, to prompt the LLM 28A to also output the anomaly score as AnomalyRuler-dummy, one may follow previous methods to calibrate the probability as natural language.

Furthermore, to compare AnomalyRuler 20 with robust reasoning with AnomalyRuler dummy and the state-of-the-art, one may let LLM 28A output an anomaly score following the previous work. Specifically, AnomalyRuler 20 may first prompt the LLM 28A to express its confidence in its answers using natural language across 17 levels, ranging from “certain” to “impossible”, then converted into numerical probabilities following.

### Experiment

This section may compare AnomalyRuler 20 with LLM-based baselines and state-of-the-art methods in terms of both detection and reasoning abilities. An ablation study on each module within AnomalyRuler 20 has been conducted as shown below to evaluate their contributions.

### Experimental Setup

### Datasets

One may evaluate the present method on four VAD benchmark datasets. (1) UCSD Ped2 (Ped2): A single-scene dataset captured in pedestrian walkways with over 4,500 frames of videos, which may include anomalies such as skating and biking. (2) CUHK Avenue (Ave): A single-scene dataset captured in the CUHK campus avenue with over 30,000 frames of videos, which may include anomalies such as running and biking. (3) ShanghaiTech (ShT): A challenging dataset that contains 13 campus scenes with over 317,000 frames of videos, which may contain anomalies such as biking, fighting, and vehicles in pedestrian areas. (4) UBnormal (UB)]: An open-set virtual dataset generated by the Cinema4D software, which may contain 29 scenes with over 236,000 frames of videos. For each dataset, one may use the default training and test sets that adhere to the one-class setting. The normal reference frames used by AnomalyRuler 20 may be randomly sampled from the normal training set. The methods may be evaluated on the entire test set if not otherwise specified.

### Evaluation Metrics

Following the common practice, one may use the Area Under the receiver operating characteristic Curve (AUC) as the main detection performance metric. To compare with LLM-based methods that cannot output anomaly scores, one may use the accuracy, precision, and recall metrics. Besides, one may adopt the Doubly-Right metric to evaluate reasoning ability. All the metrics may be calculated with frame-level ground truth labels.

### Implementation Details

One may implement the present method, AnomalyRuler 20, using PyTorch. If not otherwise specified, one may employ CogVLM-17B as the VLM for visual perception, GPT-4-1106-Preview as the LLM for induction, and the open-source Mistral-7B-Instruct-v 0.2 as the LLM for deduction due to using GPTs on entire test sets may be costly. The default hyperparameters of AnomalyRuler 20 may be set as follows: The number of batches for normal reference frames n=10, the number of frames per batch m=1, the padding size p=5, and the value of the weighting parameter α=0.33 in EMA.

Comparison with LLM-Based Baselines

Reasoning for one-class VAD using LLMs may not be well-explored. To demonstrate AnomalyRuler's superiority over the direct LLM use, one may build asking LLM/Video-based LLM directly as baselines and may adapt related works to one's target problem as baselines. At test time, let one denote test video frames as F={f₁, f₂, . . . , fᵢ}. One may elaborate on the four baselines as follows. (1) Ask LLM Directly: {LLM (dᵢ, p)|dᵢ∈D}, where D may be F's frame descriptions generated by CogVLM and p may be “Is this frame description anomaly or normal?” (2) Ask LLM with Elhafsi et al.: {LLM (dᵢ, p)|dᵢ∈D}, where D may be F's frame descriptions generated by CogVLM, and p may be prompts and pre-defined concepts of normality/anomaly. (3) Ask Video-based LLMs Directly: {Video-based LLM (cᵢ, p)|cᵢ∈C}, where p may be “Is this clip anomaly or normal?” One may use Video-LLaMA as the Video-based LLM, which may perform clip-wise inference. Each video clip cᵢ may consist of consecutive frames in F with the same label. (4) Ask GPT-4V with Cao et al.: {GPT-4V (fᵢ, p)|fᵢ∈F}, where p may be prompts. As a large VLM, GPT-4V may directly take frames as inputs.

### Detection Performance

Table 1 shown below may compare the accuracy, precision, and recall on the ShT dataset. Overall, AnomalyRuler 20 may achieve improvements with an average increase of 26.2% in accuracy and 54.3% in recall. Such improvements may be attributed to the reasoning based on the rules generated in the induction stage. In contrast, the baselines may tend to predict most samples as normal based on the implicit knowledge pre-trained in LLMs, resulting in very low recall and accuracy close to a random guess. The baselines relatively high precision is due to that they rarely predict anomalies, leading to fewer false positives.

TABLE 1
Detection performance with accuracy, precision, and recall (%) compared
with different VAD with LLM methods on the ShT dataset.

| Method | Accuracy | Precision | Recall |
|---|---|---|---|
| Ask LLM Directly | 52.1 | 97.1 | 6.2 |
| Ask LLM with Elhafsi et al. \|12\| | 58.4 | 97.9 | 15.2 |
| Ask Video-based LLM Directly | 54.7 | 85.4 | 8.5 |
| AnomalyRuler | 81.8 | 90.2 | 64.3 |

### Reasoning Performance

The reasoning performance may be evaluated using the Doubly-Right metric: {RR, RW, WR, WW} (%), where RR may denote Right detection with Right reasoning, RW may denote Right detection with Wrong reasoning, WR may denotes Right detection with Wrong reasoning, and WW denotes Wrong detection with Wrong reasoning. One may desire a high accuracy of RR (the best is 100%) and low percentages of RW, WR and WW (the best is 0%). Since {RW, WR, WW} may be caused by visual perception errors rather than reasoning errors, one may consider the case with manually corrected visual perception to exclusively evaluate each method's reasoning ability (i.e., w. Perception Errors vs. w/o. Perception Errors in Table 2 below)

Due to the lack of benchmarks for evaluating reasoning for VAD, one may create a dataset consisting of 100 randomly selected frames from the ShT test set, with an equal split of 50 normal and 50 abnormal frames. For each frame, one may offer four choices: one normal and three anomalies, where only one choice with the matched rules is labeled as RR, while the other choices correspond to RW, WR or WW. Since the 100 randomly selected frames are not consecutive, here AnomalyRuler's perception smoothing is not used.

Table 2 may show the evaluation results. With perception errors, AnomalyRuler 20 may outperform the baselines by 10% to 27% RR, and it may achieve a very low WW of 1% compared to the 17% WW of the second best Ask GPT-4V with Cao et al. Without perception errors, AnomalyRuler's RR jumps to 99%. These results demonstrate AnomalyRuler's excellence over the GPT-4 (V) baselines and its ability to make correct detection along with correct reasoning.

TABLE 2
Reasoning performance with the Doubly-Right metric: {RR, RW,
WR, WW} (%) on 100 (limited by GPT-4's query capacity)
randomly selected frames from the ShT test set. We evaluate
cases with visual perception errors (w. Perception Errors) and
with manually corrected visual perception (w/o. Perception Errors).

| | w. Perception Errors | | | | w/o. Perception Errors | | | |
|---|---|---|---|---|---|---|---|---|
| Method | RR | RW | WR | WW | RR | RW | WR | WW |
| Ask GPT-4 Directly | 57 | 4 | 15 | 24 | 73 | 3 | 0 | 24 |
| Ask GPT-4 with | 60 | 3 | 15 | 22 | 76 | 2 | 0 | 22 |
| Elhafsi et al. [ [symbol] ] | | | | | | | | |
| Ask GPT-4V with | 74 | 2 | 7 | 17 | 81 | 2 | 0 | 17 |
| Cao et al. [ [symbol] ] | | | | | | | | |
| AnomalyRuler | 84 | 1 | 15 | 1 | 99 | 0 | 0 | 1 |

[symbol]

indicates data missing or illegible when filed

Comparison with State-of-the-Art Methods

One may compare AnomalyRuler 20 with 15 state-of-the-art one-class VAD methods across four datasets, evaluating their detection performance and domain adaptability. The performance values of these methods are sourced from their respective original papers.

### Detection Performance

Table 3 below may show the effectiveness of AnomalyRuler 20. There may be three main observations. First, AnomalyRuler 20, even with its basic version AnomalyRuler-base, outperforms all the competitors on the challenging ShT and UB datasets, with improvements of 1.8% and 9.2%, respectively. This may suggest that AnomalyRuler 20 with the rule-based reasoning benefits the challenging one-class VAD task. Second, for Ped2 and Ave, AnomalyRuler 20 may perform on par with the Image-Only methods, which also do not use any additional features (e.g., bounding boxes from object detectors or 3D features from action recognition networks). This may be achieved without any tuning, meaning that the present few-normal-shot prompting approach is as effective as the costly full-shot training on these benchmarks. Third, AnomalyRuler 20 may outperform AnomalyRuler-base by 0.6% to 7.5%, indicating that the robust reasoning module can improve the performance further.

TABLE 3
AUC (%) compared with different one-class VAD methods. “Image Only” methods
only rely on image features. In contrast, others employ additional features such
as bounding boxes from object detectors or 3D features from action recognition
networks. “Training” indicates the methods that need a full-shot training process.

| Method | Venue | Image Only | Training | Ped2 | Ave | ShT | UB |
|---|---|---|---|---|---|---|---|
| MNAD [ [symbol] ] | CVPR-20 | ✓ | ✓ | 97.0 | 88.5 | 70.5 | — |
| rGAN [ [symbol] ] | ECCV-20 | ✓ | ✓ | 96.2 | 85.8 | 77.9 | — |
| CDAE [ [symbol] ] | ECCV-20 | ✓ | ✓ | 96.5 | 86.0 | 73.3 | — |
| MPN [ [symbol] ] | CVPR-21 | ✓ | ✓ | 96.9 | 89.5 | 73.8 | — |
| NGOF [ [symbol] ] | CVPR-21 | x | ✓ | 94.2 | 88.4 | 75.3 | — |
| HF2 [ [symbol] ] | ICCV-21 | x | ✓ | 99.2 | 91.1 | 76.2 | — |
| BAF [ [symbol] ] | TPAM1-21 | x | ✓ | 98.7 | 92.3 | 82.7 | 59.3 |
| BDPN [ [symbol] ] | AAAI-22 | x | ✓ | 98.3 | 90.0 | 78.1 | — |
| GCL [ [symbol] ] | CVPR-22 | x | ✓ | — | — | 79.6 | — |
| S3R [ [symbol] ] | ECCV-22 | x | ✓ | — | — | 80.5 | — |
| SSL [ [symbol] ] | ECCV-22 | x | ✓ | 99.0 | 92.2 | 84.3 | — |
| zxVAD [ [symbol] ] | WACV-23 | x | ✓ | 96.9 | — | 71.6 | — |
| HSC [ [symbol] ] | CVPR-23 | x | ✓ | 98.1 | 93.7 | 83.4 | — |
| FPDM [ [symbol] ] | ICCV-23 | ✓ | ✓ | — | 90.1 | 78.6 | 62.7 |
| SLM [ [symbol] ] | ICCV-23 | ✓ | ✓ | 97.6 | 90.9 | 78.8 | — |
| AnomalyRuler-base | — | ✓ | x | 96.5 | 82.2 | 84.6 | 69.8 |
| AnomalyRuler | — | ✓ | x | 97.9 | 89.7 | 85.2 | 71.9 |

[symbol]

indicates data missing or illegible when filed

### Domain Adaptability

Domain adaptation may consider the scenario that the source domain (i.e., training/induction) dataset differs from the target domain (i.e., testing/deduction) dataset. One may compare AnomalyRuler 20 with three state-of-the-art VAD methods that claim their domain adaptation ability. One may follow the compared works to use ShT as the source domain dataset for other target datasets. As shown in Table 4, AnomalyRuler 20 may achieve the highest AUC on Ped2, ShT and UB, outperforming with an average of 9.88%. While AnomalyRuler 20 trails zxVAD by 0.6%, it is still higher than the others with an average of 8.85%. The results may indicate that AnomalyRuler 20 may have better domain adaptability across different datasets. This advantage may be due to that the language provides consistent descriptions across different visual domains, which may allow the application of induced rules to datasets with similar anomaly scenarios but distinct visual appearances. In contrast, traditional methods extract high-dimensional visual features that may be sensitive to visual appearances, thereby struggling to transfer their knowledge across datasets.

TABLE 4
AUC (%) compared with different cross-domain VAD methods.
We follow the compared works to use ShT as the source
domain dataset for other target datasets.

| Method | Venue | Image Only | Training | Ped2 | Ave | ShT¹ | UB |
|---|---|---|---|---|---|---|---|
| rGAN [ [symbol] ] | ECCV-20 | ✓ | ✓ | 81.9 | 71.4 | 77.9 | — |
| MPN [ [symbol] ] | CVPR-21 | ✓ | ✓ | 84.7 | 74.1 | 73.8 | — |
| zxVAD [ [symbol] ] | WACV-23 | x | ✓ | 95.7 | 82.2 | 71.6 | — |
| AnomalyRuler-base | — | ✓ | x | 97.4 | 81.6 | 83.5 | 65.4 |

¹AnomalyRuler employs UB as the source domain when ShT serves as the target domain. The competitors have no cross-domain evaluation on ShT, so we report their same-domain results. [symbol]
indicates data missing or illegible when filed

### Ablation Study

In this section, one may look into how the proposed strategies may affect AnomalyRuler 20. One may investigate two aspects: rule quantity (i.e., the number of induced rules) and rule quality (i.e., their resulting performance). Regarding this, one may evaluate variants of AnomalyRuler-base on the ShT dataset.

### Ablation on Strategies

Table 5 may show the effects of removing individual strategies compared to using all strategies. In terms of rule quantity, removing Human and Environment or Normal and Anomaly may reduce rules by 47.6% and 82.4%, respectively. This reduction may be due to not separating the rules for humans and the environment halves the number of rules. Moreover, without deriving anomaly rules from normal rules, one may only have a limited set of normal rules. Removing Abstract and Concrete or Rule Aggregation may increase the number of rules, as the former merges rules within the same categories and the latter removes incorrect rules. Perception Smoothing may not affect rule quantity since it is used in the deduction stage. In terms of rule quality, removing Normal and Anomaly or Rule Aggregation may have the most negative impact. The former may happen because when only normal rules are present, the LLM may overreact to slightly different actions such as “walking with an umbrella” compared to the rule for “walking,” leading to false positives. Furthermore, without rules for anomalies as a reference, the LLM may miss anomalies. The latter may be due to perception errors in the induction stage that may lead to incorrect rules for normal. Besides, removing other strategies may decrease AUC, underscoring their significance. In summary, the proposed strategies may improve AnomalyRuler's performance. There may be no direct positive/negative correlation between rule quantity and quality, i.e., having too few rules may lead to inadequate coverage of normality and anomaly concepts while having too many rules may cause redundancy and errors.

TABLE 5
Ablation on strategies. We assess the effects of removing individual strategies in AnomalyRuler.
We conduct the experiments five times with different randomly selected normal reference frames
for induction and report their mean and standard deviation on the ShT dataset.

| | | # Rules | | Accuracy | | Precision | | Recall | | AUC | |
|---|---|---|---|---|---|---|---|---|---|---|---|
| Strategy | Stage | mean | std | mean | std | mean | std | mean | std | mean | std |
| w. All Below (default) | Both | 42.2 | 4.2 | 81.6 | 1.3 | 90.9 | 0.8 | 63.9 | 2.7 | 84.5 | 1.1 |
| w/o. Human and Environment | Both | −20.1 | +1.1 | −3.3 | +0.8 | −3.9 | +0.8 | −1.9 | +1.6 | −2.4 | +2.0 |
| w/o. Normal and Anomaly | Induction | −34.8 | −1.3 | −20.5 | +4.3 | −41.2 | +7.0 | −14.4 | +11.6 | −18.8 | +1.2 |
| w/o. Abstract and Concrete | Induction | +2.3 | +2.7 | −0.6 | −0.2 | −0.9 | −0.2 | −0.3 | −0.4 | −0.9 | +0.1 |
| w/o. Rule Aggregation | Induction | +8.5 | +6.1 | −9.6 | +14.7 | +1.1 | +2.9 | −10.7 | +14.1 | −15.8 | +0.8 |
| w/o. Perception Smoothing | Deduction | NA | NA | −1.7 | −0.9 | −1.9 | +0.1 | −3.8 | −0.3 | −3.3 | +0.8 |

### Ablation on Hyperparameters

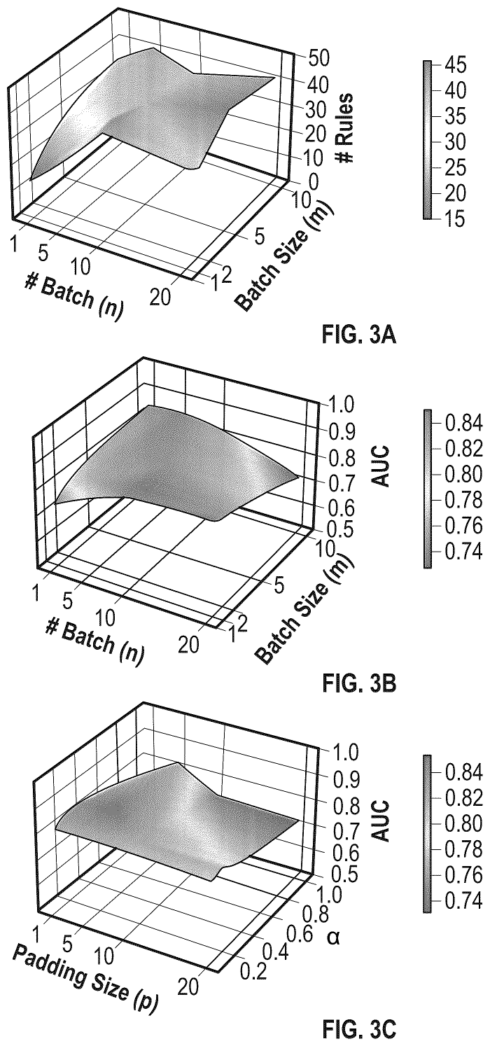

FIG. 3 may illustrate the effects of the hyper-parameters in the rule aggregation module 25 and perception smoothing module 27. For rule aggregation, one may conduct a cross-validation with n=[1, 5, 10, 20] and m=[1, 2, 5, 10], where n=1 and m=10 are the default setting. One may observe that both the number of rules and AUC may increase with the increases of n and m, but they start to fluctuate when n×m becomes large. For example, when n=20, AUC may drop from 85.9% to 72.2% as m increases because having too many reference frames (e.g., over 100) may result in redundant information in a long context. For perception smoothing, one may test p=[1, 5, 10, 20] and α=[0.09, 0.18, 0.33, 1]. One may find p=5 to be an optimal padding size for capturing the motion continuity in a video while avoiding the excessive noise that can occur with more neighborhoods. α may adjust the weight of the most recent frames compared to previous frames. A smaller α may emphasize previous frames, which may result in more smoothing but less responsiveness to recent changes. In general, increasing α from 0.09 to 0.33 may improve AUC, suggesting that moderate EMA smoothing may be beneficial.

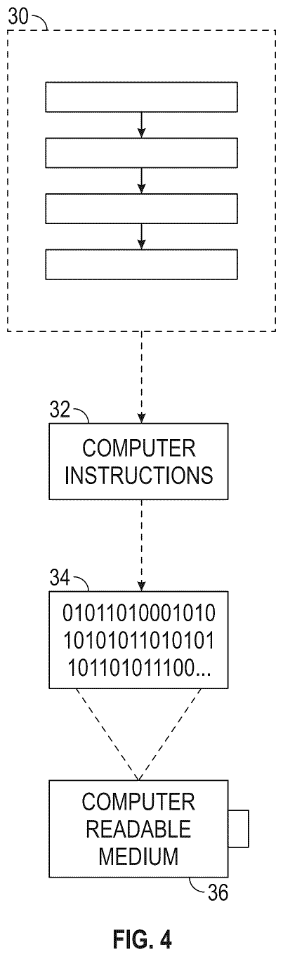

The present disclosure may be embedded in a computer program product, which includes all the features that enable the implementation of the methods described herein, and which when loaded in a computer system is able to carry out these methods. Referring to FIG. 4, in this embodiment, the method disclosed above and represented as 30 may include a computer-readable medium 36, such as a CD-R, DVD-R, flash drive, a platter of a hard disk drive, etc., on which may be encoded computer-readable data 34. This encoded computer-readable data 34, such as binary data may include a plurality of zeros and ones, in turn may include a set of processor-executable computer instructions 32 configured to operate according to one or more of the principles set forth herein. In this embodiment, the processor-executable computer instructions 32 may be configured to perform the method 30. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form.

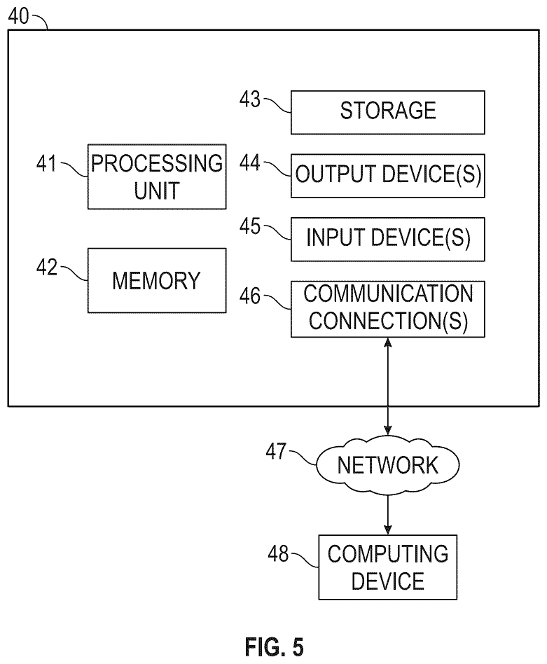

Referring to FIG. 5, a computing device 40 may be used to implement one aspect provided herein. In accordance with an embodiment, the computing device 40 may include at least one processing unit 41 and memory 42. Depending on the type of computing device, the memory 42 may be volatile, such as RAM, non-volatile, such as ROM, flash memory, etc., or a combination of the two.

In other aspects, the computing device 40 may include additional features or functionality. For example, the computing device 40 may include additional storage such as removable storage or non-removable storage, including, but not limited to, magnetic storage, optical storage, etc. Such additional storage may be illustrated in FIG. 4 by storage 43. In one embodiment, computer readable instructions to implement one aspect provided herein are in storage 43. Storage 43 may store other computer readable instructions to implement an operating system, an application program, etc. Computer readable instructions may be loaded in the memory 42 for execution by the processing unit 41, for example.

The computing device 40 may include input device(s) 44 such as keyboard, mouse, pen, voice input device, touch input device, infrared cameras, video input devices, or any other input device. Output device(s) 45 such as one or more displays, speakers, printers, or any other output device may be included with the computing device 40. Input device(s) 44 and output device(s) 45 may be connected to the computing device 40 via a wired connection, wireless connection, or any combination thereof. In one embodiment, an input device or an output device from another computing device may be used as input device(s) 44 or output device(s) 45 for the computing device 40. The computing device 40 may include communication connection(s) 46 to facilitate communications with one or more other devices 47, such as through network 47, for example.

While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure not to be limited to the particular embodiment disclosed, but that the present disclosure will include all embodiments that fall within the scope of the appended claims

1. A video anomaly detection (VAD) system comprising:
an induction stage receiving a plurality of video frames as a reference and deriving a rule for a normal event occurrence and a corresponding rule for an anomaly event occurrence by contrasting the corresponding rule for the anomaly event occurrence to the rule for the normal event occurrence; and
a deduction stage applying the rule for the normal event occurrence and the corresponding rule for the anomaly event occurrence to determine anomalies in non-reference video frames.

2. The VAD system of claim 1, wherein the induction stage comprises large language models (LLMs) to induce the rule for the normal event occurrence from a representative set of normal scenarios from the plurality of video frames as the reference and which differentiates the normal event occurrence and the anomaly event occurrence.

3. The VAD system of claim 1, wherein the induction stage comprises:
a visual perception unit converting visual features into textual descriptions from the plurality of video frames as the reference;
a rules generation unit generating the rule for the normal event occurrence and the corresponding rule for the anomaly event occurrence from the textual descriptions; and
a rules aggregation unit applying randomize smoothing to generate the rule for the normal event occurrence and the corresponding rule for the anomaly event occurrence.

4. The VAD system of claim 3, wherein the visual perception module uses a Vision Language Model (VLM) to convert visual features into textual descriptions.

5. The VAD system of claim 3, wherein the visual perception unit decouples the plurality of video frames into multiple categories.

6. The VAD system of claim 3, wherein the visual perception unit decouples the plurality of video frames into two categories, wherein the two categories are human activities and environmental objects.

7. The VAD system of claim 6, wherein the rules generation unit generates rules for human activities and environmental objectives.

8. The VAD system of claim 3, wherein the rules generation unit queries the textual descriptions and detects patterns to define the rule for the normal event occurrence.

9. The VAD system of claim 8, wherein the rules generation unit derives the corresponding rule for the anomaly event occurrence based on the rule for the normal event occurrence that has been defined.

10. The VAD system of claim 3, wherein the rules generation unit uses analogical reasoning.

11. The VAD system of claim 3, wherein the rules aggregation unit samples a plurality of batches of the video frames as the reference each containing a predefined number of frames, each of the plurality of batches of the video frames as the reference run independently through the visual perception unit and the rules generation unit to generate the rule for the normal event occurrence.

12. The VAD system of claim 11, wherein the rules aggregation unit uses a large language model (LLM) with a voting mechanism to generate the rule for the normal event occurrence based on appearance in the plurality of batches of the video frames as the reference.

13. The VAD system of claim 1, wherein the deduction stage
a visual perception unit processing the non-reference video frames and outputting the textual descriptions;
a perception smoothing unit using exponential majority smoothing for perception error reduction and temporal consistency; and
a robust reasoning module with a double-check system to reduce false negative outputs.

14. The VAD system of claim 13, wherein the perception smoothing unit uses a moving average that places a higher weighted value on more recent data points and focuses on a single category.

15. The VAD system of claim 13, wherein the robust reasoning module uses a large language model (LLM) to take a modified description from each of the nonreference video frames and a dummy answer and checks to confirm if the dummy answer matches a description based on the rule for the normal event occurrence and the corresponding rule for the anomaly event occurrence.

16. A method for video anomaly detection (VAD) comprising:
receiving a plurality of video frames as a reference;
deriving a rule for a normal event occurrence and a corresponding rule for an anomaly event occurrence by contrasting the corresponding rule for the anomaly event occurrence to the rule for the normal event occurrence; and
applying the rule for the normal event occurrence and the corresponding rule for the anomaly event occurrence to determine anomalies in non-reference video frames.

17. The method of claim 16, wherein deriving the rule for the normal event occurrence and the corresponding rule for the anomaly event comprises:
converting visual features in each of the plurality of video frames as the reference into textual descriptions;
generating the rule for the normal event occurrence and the corresponding rule for the anomaly event occurrence from the textual descriptions; and
applying randomize smoothing to generate the rule for the normal event occurrence and the corresponding rule for the anomaly event occurrence.

18. The method of claim 17, comprising decoupling the plurality of video frames into multiple categories.

19. The method of claim 17, comprising:
processing the non-reference video frames to output textual descriptions of the non-reference video frames;
applying exponential majority smoothing for perception error reduction and temporal consistency; and
applying a double-check system to reduce false negative outputs.

20. A method for video anomaly detection (VAD), the method implemented using a computer system including a processor communicatively coupled to a memory device, the method comprising:
receiving a plurality of video frames as a reference;
converting visual features into textual descriptions from the plurality of video frames as the reference;
querying the textual descriptions to detect patterns;
generating a rule for a normal event occurrence and a corresponding rule for an anomaly event occurrence based on the detected patterns;
applying randomize smoothing to generate the rule for the normal event occurrence and the corresponding rule for the anomaly event occurrence;
processing non-reference video frames to output textual descriptions from the non-reference video frames;
applying the rule for the normal event occurrence and the corresponding rule for the anomaly event occurrence to determine anomalies in the non-reference video frames;
applying exponential majority smoothing for perception error reduction and temporal consistency; and
applying a double-check system to reduce false negative outputs.
